(19) United States
(12) Patent Application Publication
(10) Pub. No.: US 2009/0075681 A1
(43) Pub. Date: Mar. 19, 2009

(54) Short Message Service Message Compactor and Uncompactor

(75) Inventor: Ivo Ruben Jager, Amstelveen (NL)

Correspondence Address: FENWICK & WEST LLP, SILICON VALLEY CENTER, 801 CALIFORNIA STREET, MOUNTAIN VIEW, CA, 94041, US

(73) Assignee: Palm, Inc., Sunnyvale, CA (US)

(21) Appl. No.: 11/857,311

(22) Filed: Sep. 18, 2007

(51) Int. Cl. H04Q 7/20

(52) U.S. Cl. 455/466

(57) ABSTRACT

A method of operating a data processing apparatus and a data processing apparatus are disclosed. A method of operating data processing apparatus comprises receiving a text file comprising a plurality of original text characters and replacing the original text characters with replacement text characters in accordance with a first rule. The replacement text characters comprise fewer text characters than the original text characters. The method further comprises determining whether or not the number of replacement text characters is less than a threshold value, and further replacing the text characters in accordance with a subsequent rule if it is determined that the umber of replacement text characters is not less than the threshold value.

### BACKGROUND

1. Field of Art

The present disclosure relates to data processing apparatus and a method of operating data processing apparatus, in particular, but not exclusively to data processing apparatus that is configured to send text messages, for example short message service (SMS) messages.

2. Description of the Related Art

Mobile telephones are known to be capable of sending short message service (SMS) messages to other mobile phones. A single SMS message can comprise a maximum of 160 text characters. If a user enters a message that exceeds 160 characters, the text characters are segmented over a plurality of concatenated individual SMS messages. In order that the individual SMS messages can be reassembled at the receiver a user data header (UDH) containing segmentation information is incorporated into the payload of the SMS messages thereby reducing the maximum number of characters that can be included in each of the individual SMS messages/segments to a number lower than 160. In a 7-bit encoding example, the maximum number of text characters than can be included in a segment of a segmented SMS message is 153. In examples that use different types of encoding the maximum number of text characters in a segmented SMS may be different.

### SUMMARY

Aspects and embodiments disclosed herein were devised with the foregoing in mind. For example, in a first aspect, a method of operating data processing apparatus receives a text file comprising a plurality of original text characters; replaces the original text characters with replacement text characters in accordance with a first rule, wherein the replacement text characters comprise fewer text characters than the original text characters; determines whether or not the number of replacement text characters is less than a threshold value; and further replacing the text characters in accordance with a subsequent rule if it is determined that the number of replacement text characters is not less than the threshold value.

Viewed from a second aspect, there is provided a data processing apparatus that comprises a receiver configured to receive a text file comprising a plurality of original text characters; and a processor that is configured to: replace the original text characters with replacement text characters in accordance with a first rule, wherein the replacement text characters comprise fewer text characters than the original text characters; determine whether or not the number of replacement text characters is less than a threshold value; and further replace the text characters in accordance with a subsequent rule if it is determined that the number of replacement text characters is not less than the threshold value.

Further replacing text characters in accordance with a subsequent rule if it is determined that the number of replacement text characters is not less than the threshold value can enable an efficient amount of memory and/or bandwidth to be used for storing and subsequently sending the text message to a third party device. The reduced number of characters requires less memory than the original characters and the use of the threshold can provide that the total number of characters is not unnecessarily reduced to a number significantly below the threshold. Unnecessarily reducing the number of characters can detract from the legibility/clarity of the text.

Use of a threshold can provide a compromise between saving memory by reducing the number of characters in the text file and reducing the legibility of the text file having a reduced number of characters. The received text file may be configured for sending by SMS. Embodiments using the Short Message Service (SMS) standard can benefit from using a threshold that coincides with a predetermined maximum number of characters for a segment of a segmented long message. Reducing the number of characters to a number that is just below the threshold can reduce the number of segments that are required to send the long message whilst retaining a degree of legibility of the text message.

The method may comprise repeating steps to determine whether or not the number of replacement text characters is less than a threshold value and further replacing the text characters in accordance with a subsequent rule if it is determined that the number of replacement text characters is not less than the threshold value. Similarly, the processor may be configured to repeatedly determine whether or not the number of replacement text characters is less than a threshold value; and further replace the text characters in accordance with a subsequent rule if it is determined that the number of replacement text characters is not less than the threshold value until the number of replacement characters is less than the threshold value. Applying subsequent rules one at a time until the threshold is met can enable the number of text characters to be gradually reduced, thereby reducing the chances that the number of text characters is unnecessarily reduced once the threshold has been met.

Furthermore, controlling the order in which the rules are applied can enable a priority to be associated with the rules. The priority associated with the rules can enable a first set of replacement text according to a first rule to be used before a subsequent set of replacement text according to a subsequent rule, wherein the first set of replacement text can be considered more legible/understandable that the second set of replacement text.

The replacement text characters may be discernible to a human user. The replacement text characters may make up words and phrases that are discernible to the human user in their native language. Using replacement text characters that are discernible to a human user can ensure that a recipient of the text file containing replacement characters can read the text file even if their device is not capable of translating the replacement text characters back to the original text characters.

The first rule and/or subsequent rule(s) may comprise an association between original words and phrases, and replacement words and phrases. The association may in the form of a database. The association between the original words and phrases, and the replacement words and phrases can enable original characters to be translated into the replacement characters by using abbreviated words/phrases. The replacement words and/or phrases may be “txtspeak”.

The association between original words/phrases and replacement words/phrases may be user-definable. This can enable a user to control how, and in which order, text characters are replaced. The user can thus make sure that more readily human discernible replacement words are used before falling back to less readily human discernible replacement words if a threshold cannot been met.

The threshold value may correspond to a maximum number of characters that can be included in an integer multiple of messaging data packets. This can enable a reduced or minimized number of messaging data packets to be used to send the text file/message.

The replacement text characters may be displayed on a display. This can provide a user with the opportunity to approve the replacement text characters before they are subsequently sent to a third party device or reject the replacement text characters in order to go back to the original text characters, for example if a threshold cannot be met. It is noted that the replacement text characters may be stored as a replacement text file in memory. The replacement text file may be sent to a target device.

There may be provided a computer program comprising machine or computer-readable program elements for configuring a data processing apparatus or to configure a data processing apparatus according to an aspect of this disclosure and/or to implement a method according to an aspect of this disclosure. Further, there may be provided a carrier medium carrying the computer program, and the carrier medium may be one of the following: solid-state memory; magnetic memory; CD-ROM; digital versatile disk (DVD); read-write CD; an electronic signal; radio frequency carrier wave or optical carrier wave.

The data processing apparatus may be a communications device, preferably a wireless/mobile communications device. The wireless communications device may be configured for cellular telephony, such as a mobile telephone. The data processing apparatus may be a computing device, preferably a mobile computing device such as a personal digital assistant (PDA), and may be a personal computer (PC) or a laptop. The communications device may be handheld.

The features and used described in the specification are not all inclusive and, in particular, many additional features and uses will be apparent to one of ordinary skill in the art in view of the drawings, specification, and claims. Moreover, is should be noted that the language used in the specification has been principally selected for readability and instructional purposes, and may not have been selected to delineate or circumscribe the disclosed subject matter.

### BRIEF DESCRIPTION OF DRAWINGS

The disclosed embodiments have other uses and features which will be more readily apparent from the detailed description, the appended claims and accompanying drawings, in which:

FIG. 1 illustrates an embodiment of a data processing apparatus;

FIG. 2 illustrates an embodiment of a hierarchical library of abbreviations;

FIG. 3 illustrates a process flow diagram showing an embodiment of steps performed for operation of a data processing apparatus; and

FIG. 5 illustrates another process flow diagram showing another embodiment of steps performed for operation of a data processing apparatus.

### DETAILED DESCRIPTION

The Figures (FIGS.) and the following description relate to particular embodiments by way of illustration only. It should be noted that from the following discussion, optional embodiments of the structures and methods disclosed herein will be readily recognized as viable options that may be employed without departing from the principles of the claimed subject-matter.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that optional embodiments of the structures and methods illustrated herein may be employed without departing from the principles described herein.

Embodiments of the present disclosure relate to data processing apparatus that are configured to transmit text messages such as SMS messages, emails and instant messaging (IM) messages. Embodiments described herein can reduce the amount of bandwidth required to send such text messages, and in embodiments where the data processing apparatus comprises a mobile phone that is configured to send SMS messages, the total number of segmented SMS messages that are required to send a long text message may be reduced. A “long” text message” may be considered as one that more characters than can be accommodated by a single message data packet according to the messaging standard being used.

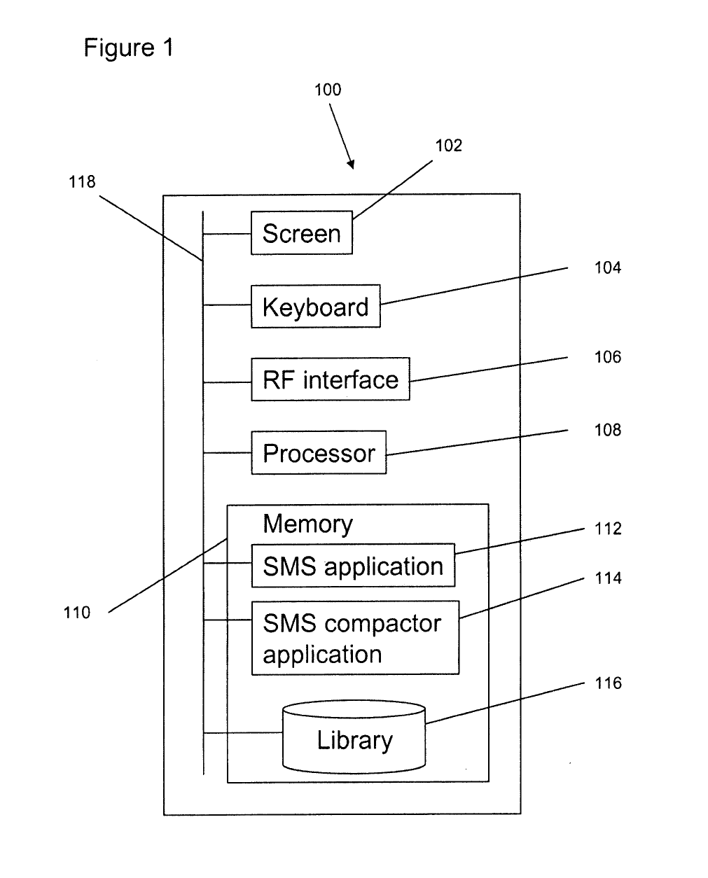

FIG. 1 illustrates an embodiment of a data processing apparatus, which in this embodiment is a mobile telephone 100. Example mobile phones include 12, 20, or 24-key keypad mobile phones. Other example mobile phones include smartphones having mechanical or on-screen character keypads in a keyboard type layout. By way of example, such keyboard type layouts include a ‘QWERTY’ (having, inter alia, ‘Q’, ‘W’, ‘E’, ‘R’, ‘T’, ‘Y’, keys successively in a row), ‘AZERTY’, ‘QWERTZ’, ‘QZERTY’, Dvorak, or double-byte keys keypad layout.

The mobile telephone 100 comprises a screen 102, a keyboard 104, an RF interface 106, a processor 108 and a memory 110, all of which are connected to a data bus 118. Stored in memory 110 is an SMS application program 112, an SMS compactor application program 114, and a hierarchical library of abbreviations stored in a database 116.

The keyboard 104 enables a user of the mobile telephone 100 to open the SMS application 112 and type in a text message. The processor 108 is configured to run the SMS application 112 and provide a graphical user interface to the user on the screen 102. The RF interface 106 is configured to send the SMS message to a target device responsive to user input via the keyboard 104 to that effect. It is noted that the keypad can be mechanical or on-screen and may in some instances comprise a combination thereof, e.g., on on-screen haptic keypad or touch sensitive keypad.

Also stored in memory is SMS compactor application 114 which is configured to be run by processor 110 responsive to a signal representative of a user selecting an option to compact the SMS message received from keyboard 104. A user may wish to compact a text message to reduce the number of characters in the text message, thereby reducing the total number of segmented SMS messages that are required to transmit a long text message. This can reduce the cost of sending the message and reduce the bandwidth required to send the message.

The number of characters in the text message can be reduced by applying rules to replace original words and/or phrases (which may include characters including punctuation and spaces in addition to alphanumeric characters) with replacement words and/or phrases having fewer characters as identified in the hierarchical library of abbreviations 116. The replacement words and/or phrases may be abbreviations of the original words and/or phrases and may utilize an “SMS language”. An SMS language (which may be known as chatspeak, txt, txt spk, txtspk, texting language or txt talk) can be a slang or “lingo” used in mobile phone SMS. In some embodiments, a user can define how words and/or phrases are abbreviated.

In some embodiments, the SMS compactor application can be selected by a user pressing a button on the keyboard 104 to select an “SMS compact” operation prior to selecting an option to send the SMS message. In other embodiments, the SMS compactor application 114 may be automatically run after a user selects an option on the keyboard 104 to send the SMS message, but before the associated data packets are sent to the RF interface 106 for transmission to the target device. In this way, the data packets that are subsequently transmitted by the RF interface 106 following SMS compaction can comprise fewer data bits, and therefore require less computing resource to send the SMS message to the target device. Compacting the text message can reduce the amount of bandwidth that is required to transmit the one or more the SMS messages.

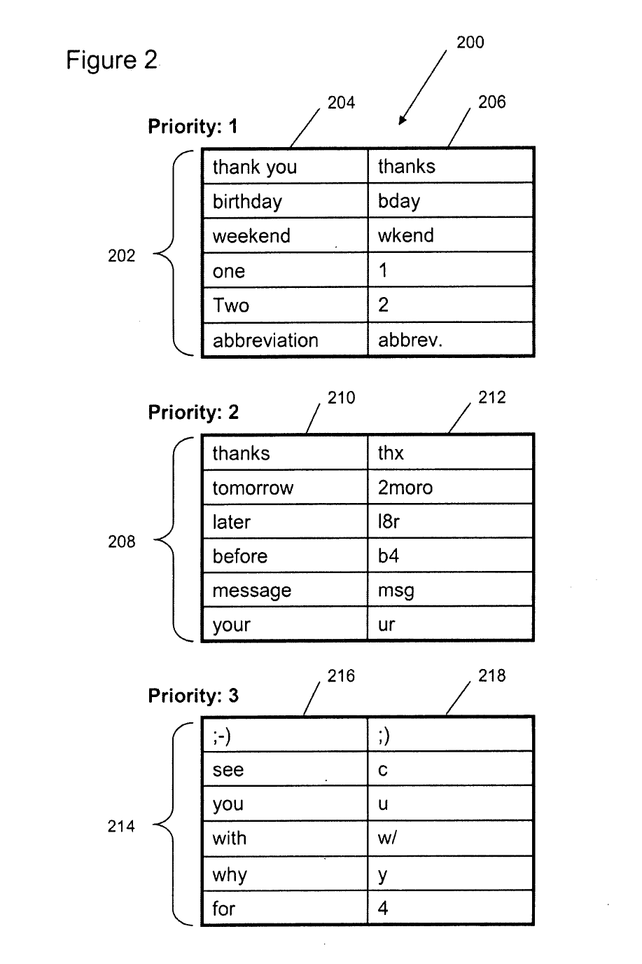

When the SMS compactor application 114 is run, it applies one or more of a series of rules to the text message, which in this embodiment is the application of one or more abbreviations from the hierarchical library of abbreviations 106. Applying the rules replaces original words and/or phrases with replacement words and/or phrases that have fewer text characters than the originals, thereby reducing the number of text characters in the message. An example of this is described in relation to FIG. 2.

FIG. 2 shows an embodiment of a hierarchical library of abbreviations 200. In this embodiment, the library of abbreviations 200 comprises three tables of abbreviations 202, 208, 214, wherein the first table of abbreviations 202 has a higher priority than the second table of abbreviations 208, which in turn has a higher priority than the third table of abbreviations 214. The first table of abbreviations 202 comprises a column of original words 204 and a column of corresponding abbreviated words 206. The first entry in the first table of abbreviations 202 has an original word of “thank you” associated with an abbreviated word of “thanks”.

In this embodiment, the first table of abbreviations 202 is configured to be applied to words and/or phrases in the text message that the user has entered and replace any identified original words 204 with the corresponding abbreviated word 206. The first table of abbreviations is configured to reduce the number of characters in the text message, but without detracting from the original structure of the text message too much. That is, the degree of “jargon” such as (SMS txt spk) present in the amended text message can be limited. This can be a subjective test, and therefore in some embodiments the entries in the tables of abbreviations 202, 208, 214 and/or their associated priorities can be user-defined.

The second table of abbreviations 208 is configured to be applied to a text message if the first table of abbreviations 202 does not reduce the number of characters in the text message below a predefined threshold. In a 7-bit encoding SMS example, the predefined threshold may be 160 characters for a single SMS message and a multiple of 153 if the total number of characters cannot be reduced to below 160. In this embodiment, the second table of abbreviations 208 is configured to be applied to the amended original text message after the first table of abbreviations 202 has been applied.

As an example, if the phrase “thank you” is present in the original text message, it will be replaced with “thanks” following application of the first abbreviations table 202 thereby reducing the number of characters by 3. The subsequent application of the second table of abbreviations 208 will further abbreviate “thanks” to “thx” thereby further abbreviating the original “thank you”. Application of the second table 208 further reduces the number of characters by a further 3; that is the number of characters is reduced by 6 when compared with the original phrase of “thank you”.

The second table of abbreviations 208 is configured to apply a further level of abstraction, and therefore increases the level of jargon compared to the first level of abstraction applied by the first table of abbreviations 202. Similarly, the third table of abbreviations 214 is configured to apply a still further level of abstraction to the original SMS message, thereby reducing the number of characters in the SMS message further.

In some embodiments, further tables of abbreviations may be applied to further reduce the number of characters in the text message. As an example, any spaces that are present before or after punctuation marks may be removed by an appropriate table of abbreviations. For example, “.” may be replaced with “.”, thereby removing two characters (the spaces after the period). As another example, spaces may be removed from the text message and the first letter of the words can be capitalized such that a user can identify where one word ends, and the next one starts.

It will be appreciated, that the number of tables of abbreviation 202, 208, 214 that are used, and the contents of those tables, is a compromise between the clarity/legibility of the message, and the amount of bandwidth that is required to transmit the message. This compromise may be controllable by a user defining the contents of the tables, and their priorities.

A single table of abbreviations may contain only an association between a single original word and a single abbreviated word. This can provide good control of the level of abstraction that is applied to the text message as the original words can be replaced one at a time until a predetermined stopping point, such as a threshold being reached.

In an embodiment using the SMS standard, the SMS standard is configured to split the text message into segmented SMS messages wherein each segment has a maximum number of characters of 160 if a single SMS message is sufficient, and a multiple of 153 characters if 160 characters is not sufficient, in a 7-bit encoding example.

In some embodiments the number of characters may be reduced to a number just below 160, or the lowest multiple of 153, in order that the clarity/legibility of the text message is retained as much as is possible without abbreviating the text message further than is necessary. Abbreviating the text message further would not reduce the amount of bandwidth that is required to send the SMS segments and therefore would not reduce the cost to the user for sending that message. In one example, the costs associated with sending by SMS an original text message comprising 350 characters would have been the cost of sending three segmented SMS messages, whereas if the number of characters can be reduced to 304 characters the cost of sending only two segmented SMS messages would be incurred.

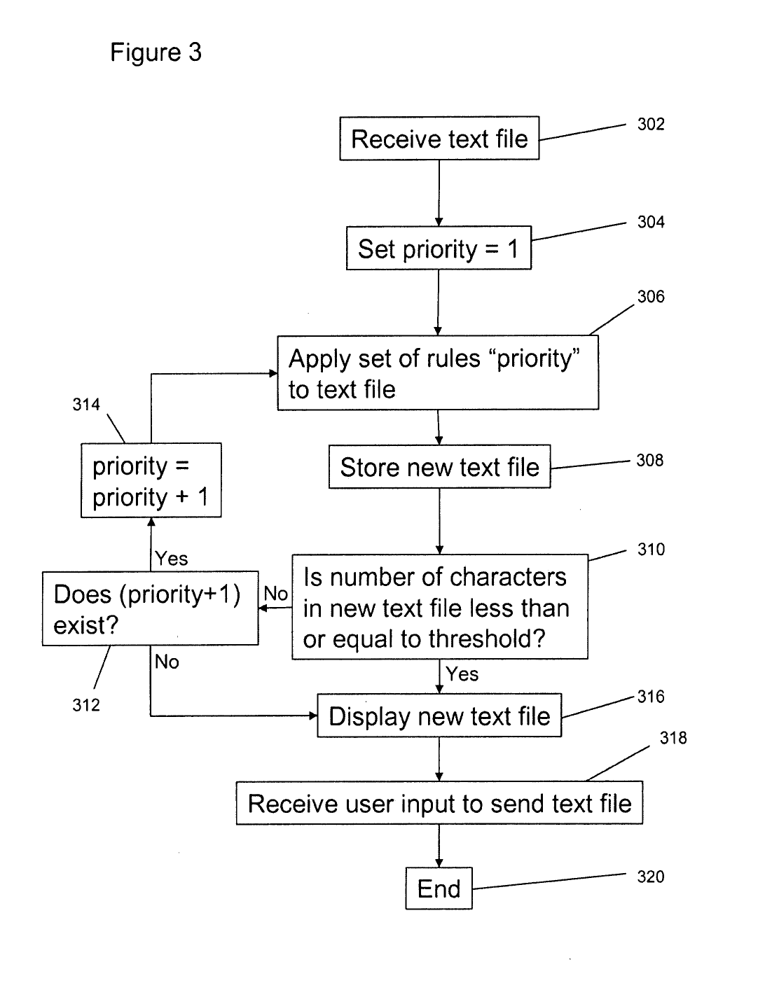

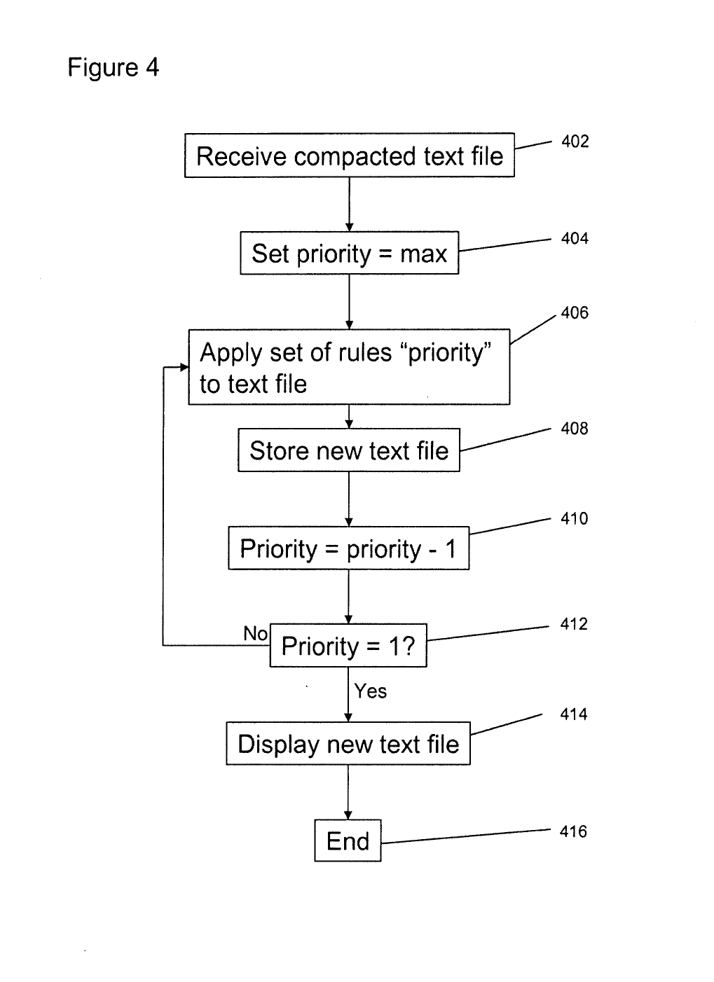

FIG. 3 illustrates a process flow control diagram showing an embodiment of steps performed for operation of a data processing apparatus. The data processing apparatus may be a mobile telephone as described in relation to FIG. 1, or a personal digital assistant (PDA), a personal computer, or any other computing device that is configured to send text messages such as SMS messages, emails, and instant messaging (IM) messages.

At step 302, a text file is received. The text file may be generated by a user typing in a text message using a keyboard (or keypad) associated with the data processing apparatus (e.g., mobile phone or mobile computing device), or the text file may be retrieved from memory.

At step 304, a variable “priority” is initially set to 1. During operation, the variable “priority” is incremented to step through a hierarchical set of rules that are to be applied to the received text file one at a time. The set of rules may correspond to the first, second and third tables of abbreviations 202, 208, 214 described in FIG. 2. The variable “priority” is initially set as 1 to begin at the highest priority rule/level of abbreviation.

At step 306, a set of rules associated with a priority of 1 is applied to the received text file, and the new text file that is generated by applying the set of rules is stored in the memory at step 308. The new text file may be stored in memory to overwrite the received file, or may be stored in memory at a different location top the received text file. As the subsequent rules are applied, the further abbreviated new text files may overwrite the previously abbreviated text files or may be stored at another new location in memory.

At step 310, a comparison is made between the number of characters in the new text file and a threshold value. For example, for an SMS text file, the threshold may be 160, or any multiple of 153 that is greater than 160. In some embodiments, the threshold may be dynamically set. For example, the initial threshold may be set as 160 in an attempt to reduce the text file to few enough characters to fit within a single SMS message. If this threshold is not achievable for a given text file, the original text may be re-abbreviated with a threshold value of 306 (or any other appropriate value) in an attempt to reduce the text file to few enough characters to fit within two segmented SMS messages, and so on. Optionally, if a threshold cannot be met at step 310, the fully abbreviated/compacted text may be un-compacted until the total number of characters is just below a higher threshold, thereby using as many text characters as possible whilst still only using a reduced, or the minimum, number of SMS segmented messages.

The process flow moves to step 312 if it is determined that the number of characters in the new text file is not less than or equal to the threshold. At step 3 12, a determination is made as to whether or not a subsequent set of rules exist. If it is determined that a subsequent set of rules (priority+1) does exist, the process flow moves on to step 314 where the variable “priority” is incremented, and then moves on to step 306 where the subsequent set of rules is applied to the amended text file.

If it is determined at step 310 that the number of characters in the new text file is less than or equal to the threshold, or it is determined at step 312 that a subsequent set of rules does not exist, the process flow moves on to step 316 where the new text file is displayed to the user.

In this embodiment, the process flow moves on to step 318 to await a signal indicative of a user input that the new text file should be sent, for example by a user pressing a “send” button after reviewing the new text file. In other embodiments, further user input at step 318 is not required, and the process flow automatically moves on to step 320 to send the text file to the target device.

As a worked example of the process flow illustrated in FIG. 3, with the application of the sets of rules/tables of abbreviation 202, 208, 214 illustrated in FIG. 2, a received text file of “thank you Bill, I'll see you tomorrow” will be considered, with a threshold value of 30 characters. Initially, a user opens an SMS application on their mobile telephone and types in the text message “thank you Bill, I'll see you tomorrow”, and this is the text file that is received at step 302. At step 304, the variable “priority” is set as 1, and the associated set of rules/table of abbreviation 202 with priority 1 is applied at step 306.

Following the application of set of rules 1, the text message has been amended to “thanks Bill, I'll see you tomorrow” and the amended text file is stored in memory at step 308. At step 310, the number of characters in the new text file (34) is compared to the threshold of 30 characters, and determines that the number of characters in the text file is not less than or equal to the threshold. Therefore, the method moves on to step 312 to determine whether a second set of rules exists. In this example a second set of rules/table of abbreviations 208 does exist, and therefore the process flow returns to step 306 to apply the second set of rules.

Following application of the second set of rules, the new text file that is stored in memory at step 308 comprises the following message: “thx Bill, I'll see you 2moro”. The new text file consists of 28 characters. This time, when the comparison between the number of characters in the new text file and the threshold is performed at step 310, the number of characters in the new text file is less than or equal to the threshold of 30. Therefore, the process flow moves on to step 316 to display the new text file to the user. Subsequently, the user may send the text file if the user indicates that they are happy with it at step 318.

In another example, where the threshold is 20 characters, the third set of rules would be applied. In this process, the text file would be amended to read: “thx Bill, I'll c u 2moro”, which consists of 24 characters. As this new text file still does not meet the threshold, the process flow moves to step 312. However, in this example, as there are no further sets of rules, the process flow moves on to step 316 to display the text file having 24 characters to the user. The user can decide whether or not they wish to send that text file, even though the threshold has not been met. The user may be able to select an option to reject the abbreviations so that they can send the original text file.

In some embodiments, a data processing apparatus that is configured to receive a text file, for example, the data processing apparatus associated with the target device that the SMS message has been sent to by the operation of the process flow described in FIG. 3, may also comprise a corresponding text file compactor application. In such embodiments, the rules and/or tables of abbreviation may be applied in reverse order to un-compact the received compacted text file. This can improve the legibility/clarity of the received message at the target device by removing the “SMS text jargon”, but still benefits from the advantages that the volume of data that has been transmitted to provide the message is reduced. An advantage associated with transmitting the message in an abbreviated form is that it can still be deciphered by a user of the target device, independent of whether or not the target device has the same, or indeed any, text file compactor application software.

FIG. 4 illustrates an embodiment of a process flow to un-compact a text message. At step 402 a compacted text file is received. At step 404, the variable “priority” is set at its maximum value, which corresponds to the lowest priority set of rules that can be applied to the received text file.

In some embodiments, the lowest priority set of rules is applied first, as this can have a repercussive effect on the application of subsequent rules. For example, “thx” should be translated to “thanks” by application of the second table of abbreviations 208 in FIG. 2, before “thanks” is subsequently translated back to “thank you” by the first table of abbreviations 202. If the tables of abbreviations 202, 208 were not applied in this order, “thx” would not be fully expanded to “thank you”, but would only be expanded as far as “thanks”.

At step 406, the lowest priority set of rules is applied to the received text file, and the amended text file is stored at 408. At step 410, the variable “priority” is decremented, and at step 412, a determination is made as to whether or not variable “priority” equals one. That is, whether or not any higher priority sets of rules exist. If “priority” does not equal one, then a further set of rules does exist and the process flow returns to step 406. If it is determined at step 412 that “priority” does equal one, then all sets of rules have been applied, and the new text file is displayed to the user at step 414, and the process flow ends at step 416.

In some embodiments, the process flow illustrated in FIG. 4 is performed responsive to a signal representative of a user selecting an “un-compact text file” option. In other embodiments, the process flow illustrated in FIG. 4 may be performed automatically upon receipt of a text file, and in some embodiments the process flow may be performed upon receipt of a text file of a certain type, for example an SMS message.

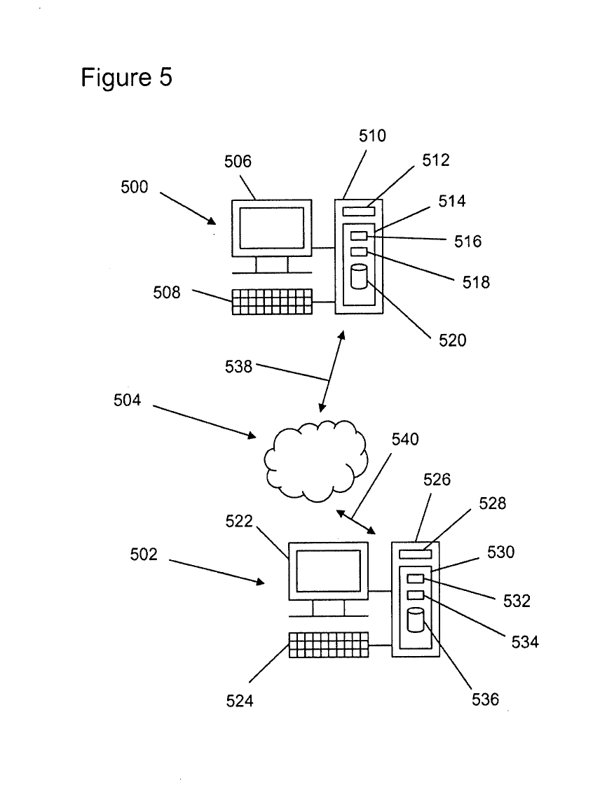

FIG. 5 illustrates an embodiment of two personal computers 500, 502 that are configured to communicate with each other over a network 504 such as the internet. The first computer 500 is connected to a monitor 506 and a keyboard 508. The computer 500 comprises a processor 512 and memory 514. A communications application 516 such as an instant messaging application program or an email application program is stored on memory 514, as is a text file compactor application 518 and a set of rules stored in the database 520. The set of rules 520 are configured to be applied to a text file by the text file compactor application 518. Similarly, the second computer 512 comprises the same components, and is also connected to a monitor 522 and a keyboard 524.

In this embodiment, a user of the first computer 500 can type in an email or instant message, for example, using keyboard 508 associated with the first computer 500. The user initiates a communications application 516 to send a corresponding text file to the second computer 502. Prior to sending the text file to the second computer 502, the communications application 516 of the first computer 500 calls the text file compactor application 518 to automatically reduce the number of characters in the text file. As described above, the text file compactor application 518 uses the set of rules 520 stored in local memory 514 to reduce the number of characters in the text message.

Following the application of the text file compactor application 518, the communications application 516 automatically generates a signal representative of the amended text file. The communication application 516 causes an input/output device (not shown) of the first computer 500 to transmit the signal over the internet 504 to the second computer 502. The data transmission over the internet is shown schematically as arrows 538 and 540.

Upon receipt of the signal representative of the amended text file by second computer 502, the communications application 532 associated with the second computer 502 automatically calls a corresponding text file compactor application 534 which utilizes the same set of rules 536 that were used to compact the text file by first computer 500, to un-compact the received text file. The communications application 532 of the second computer 502 then causes the un-compacted text file to be displayed to a user of the second computer 502 on screen 522.

In other embodiments, a threshold may not be present as there may not be any discrete boundaries at which the number of characters present in the text file disproportionately affects the bandwidth that is required to send that text file, and/or the cost of sending the text file. In such embodiments, the rules associated with each of the priorities may be applied to the text file before subsequent transmission of the abbreviated/compacted text file, thereby minimizing the number of text characters. It will be appreciated that by compacting the text file prior to transmission, the amount of data that is transmitted over the internet 504 is reduced, and therefore transmission speeds can be increased, and less bandwidth can be used.

Insofar as embodiments described above are implementable, at least in part, using a software-controlled programmable processing device such as a general purpose processor or special-purposes processor, digital signal processor, microprocessor, or other processing device, data processing apparatus or computer system, it will be appreciated that a computer program (or program product) for configuring a programmable device, apparatus or system to implement the foregoing described methods, apparatus and system is envisaged as an aspect of the described embodiments (e.g., of FIGS. 3, 4, 5). The computer program may be embodied as any suitable type of code, such as source code, object code, compiled code, interpreted code, executable code, static code, dynamic code, and the like. The instructions may be implemented using any suitable high-level, low-level, object-oriented, visual, compiled and/or interpreted programming language, such as C, C++, Java, BASIC, Perl, Matlab, Pascal, Visual BASIC, JAVA, ActiveX, assembly language, machine code, and so forth. A skilled person would readily understand that term “computer” in its most general sense encompasses programmable devices such as referred to above, and data processing apparatus and computer systems.

Suitably, the computer program is stored on a carrier medium in machine readable form, for example, the carrier medium may comprise memory, removable or non-removable media, erasable or non-erasable media, writeable or re-writeable media, digital or analog media, hard disk, floppy disk, Compact Disk Read Only Memory (CD-ROM), Company Disk Recordable (CD-R), Compact Disk Rewriteable (CD-RW), optical disk, magnetic media, magneto-optical media, removable memory cards or disks, various types of Digital Versatile Disk (DVD) subscriber identify module, tape, cassette solid-state memory. The computer program may be supplied from a remote source embodied in the communications medium such as an electronic signal, radio frequency carrier wave or optical carrier waves. Such carrier media are also envisaged as aspects of the present invention.

An example of the foregoing includes a data processing apparatus such as a mobile telephone, a personal digital assistant, a smartphone, or a personal (or laptop or notebook) computer that includes a receiver and a processor. The receiver is configured to receive a text file comprising a plurality of original text characters. The processor is configured to (a) replace the original text characters with replacement text characters in accordance with a first rule, wherein the replacement text characters comprise fewer text characters than the original text characters, (b) determine whether or not the number of replacement text characters is less than a threshold value, and (c) further replace the text characters in accordance with a subsequent rule if it is determined that the number of replacement text characters is not less than the threshold value. To perform the particular tasks, the processor retrieves instructions from a computer program that may be stored on a carrier medium. The carrier medium is a one of the following: solid-state memory; magnetic memory; CD-ROM; digital versatile disk (DVD); read-write CD; an electronic signal; radio frequency carrier wave or optical carrier wave.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the invention. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for data processing system and process that include an SMS compactor (and de-compactor) through the disclosed principles herein. Thus, while particular embodiments and applications have been illustrated and described, it is to be understood that the present invention is not limited to the precise construction and components disclosed herein and that various modifications, changes and variations which will be apparent to those skilled in the art may be made in the arrangement, operation and details of the method and apparatus of the disclosed aspects herein without departing from the spirit and scope as defined in the appended claims.

What is claimed is:

1. A method of operating data processing apparatus comprising:
receiving a text file comprising a plurality of original text characters;
replacing the original text characters with replacement text characters in accordance with a first rule, wherein the replacement text characters comprise fewer text characters than the original text characters;
determining whether or not the number of replacement text characters is less than a threshold value; and
further replacing the text characters in accordance with a subsequent rule if it is determined that the number of replacement text characters is not less than the threshold value.

2. The method of claim 1, wherein the received text file is configured for sending by short message service (SMS).

3. The method of claim 1, further comprising repeating, until the number of replacement text characters is less than the threshold value, the steps of determining whether or not the number of replacement text characters is less than a threshold value and further replacing the text characters in accordance with a subsequent rule if it is determined that the number of replacement text characters is not less than the threshold value

4. The method of claim 1, wherein the replacement text characters comprise a decipherable phrase.

5. The method of claim 1, wherein the first rule and subsequent rule comprises an association between original words and phrases, and replacement words and phrases.

6. The method of claim 5, wherein at least one of the replacement words and phrases is “txtspeak”.

7. The method of claim 5, wherein the association between original words and phrases, and replacement words and phrases, are user-definable.

8. The method of claim 1, wherein the threshold value corresponds to a maximum number of characters that can be included in an integer multiple of messaging data packets.

9. The method of claim 1, further comprising displaying the replacement text characters on a display.

10. The method of claim 1, further comprising storing the replacement text characters as a replacement text file in memory.

12. The method of claim 11, further comprising sending the replacement text file to a target device.

13. A data processing apparatus comprising:
a receiver configured to receive a text file comprising a plurality of original text characters; and
a processor configured to:
replace the original text characters with replacement text characters in accordance with a first rule, wherein the replacement text characters comprise fewer text characters than the original text characters,
determine whether or not the number of replacement text characters is less than a threshold value, and
further replace the text characters in accordance with a subsequent rule if it is determined that the number of replacement text characters is not less than the threshold value.

14. The data processing apparatus of claim 13, wherein the processor is further configured to output the replacement text characters if it is determined that the number of replacement text characters less than or equal to the threshold value.

15. The data processing apparatus of claim 13, wherein the data processing apparatus comprises one of a mobile computing device, a mobile telephone, a personal digital assistant, a personal computer and a laptop.

16. A mobile computing device configured to communicate using short message service (SMS), the mobile computing device comprising:
a memory; and
a processor,
a SMS application stored as instructions in the memory, the instructions when executed by the processor cause the processor to receive a text file comprising a plurality of original text characters, and
a SMS compactor program application stored as instructions in the memory, the instructions when executed by the processor cause the processor to:
replace the original text characters with replacement text characters in accordance with a first rule, wherein the replacement text characters comprise fewer text characters than the original text characters,
determine whether or not the number of replacement text characters is less than a threshold value,
further replace the text characters in accordance with a subsequent rule in response to the number of replacement text characters not less than the threshold value, and
output the replacement text characters in response to the number of replacement text characters less than the threshold value.

17. The mobile computing device of claim 16, wherein the SMS compactor application further comprises instructions that cause the processor to output the replacement text characters in response to the number of replacement text characters equal to the threshold value.

18. The mobile computing device of claim 16, wherein the SMS compactor application further comprises instructions that cause the processor to transmit the output of the replacement text characters to the SMS application.

19. The mobile computing device of claim 18, wherein the SMS application further comprises instructions that cause the processor to display the replacement text characters on a screen of the mobile computing device.

20. The mobile computing device of claim 18, wherein the SMS application further comprises instructions that cause the processor to transmit the replacement text characters in response to receiving a user initiated signal to transmit the message.

21. A mobile computing device configured to communicate using short message service (SMS), the mobile computing device comprising:
a memory; and
a processor,
a SMS application stored as instructions in the memory, the instructions when executed by the processor cause the processor to receive a text file comprising replacement text characters, the replacement text characters comprising text compacted from original text characters, the replacement text characters comprising fewer text characters than the original text characters, and
a SMS uncompactor application stored as instructions in the memory, the instructions when executed by the processor cause the processor to:
replace the plurality of replacement text characters with text characters in accordance with a first rule, the text characters comprising a first set of expanded text characters corresponding to the replacement text characters,
determine whether a next level of priority rules exists,
further replace the first set of expanded text characters with a second set of expanded text characters in accordance with a subsequent rule in response to the existence of a next level of priority rules, and
output the first or the second expanded text characters in response to no additional level of priority rules.

22. The mobile computing device of claim 21, wherein at least one of the first or the second expanded text characters comprises the original text.

23. The mobile computing device of claim 21, wherein the SMS application further comprises instructions that cause the processor to display a request on a screen of the mobile computing device asking whether to expand the text.

24. The mobile computing device of claim 21, wherein the SMS uncompactor application further comprises instructions that cause the processor to display on a screen of the mobile computing device suggested expanded text for user review prior to expanding the text.
